(19) United States
(12) Patent Application Publication
(10) Pub. No.: US 2025/0309630 A1
(43) Pub. Date: Oct. 2, 2025

(54) ELECTRIC CHARGE SHIELDING DEVICE

(71) Applicant: GROUND LIGHTNING S.A.S, Santander (CO)

(72) Inventor: Henry Sandoval Becerra, Santander (CO)

(21) Appl. No.: 18/864,513

(22) PCT Filed: May 11, 2023
(86) PCT No.: PCT/IB2023/054903

§ 371 Date: Nov. 8, 2024

(30) Foreign Application Priority Data
May 11, 2022 (CO) NC2022/0006162

(51) Int. Cl. H02G 13/00

(52) U.S. Cl. CPC H02G 13/80; H02G 13/20; H02G 13/40

(57) ABSTRACT

The present disclosure relates to a shielding device against atmospheric discharges. The device comprises a first conductive element and a second conductive element that passes through the first conductive element, wherein both conductive elements are electrically insulated by means of a first insulating body, and a second insulating body that are connected to the ends of the first conductive element and the second conductive element. Additionally, the device comprises a third conductive element that passes through the second conductive element that is connected to a fourth conductive element. The fourth conductive element is connected to one of the ends of the first and second conductive elements, and the shape of the fourth conductive element prevents the generation of a corona effect in the presence of an electric discharge. In addition, the third conductive element allows the lightning shielding device to be connected to a grounding element, thus concentrating the electric discharge only in the lightning shielding device, acting as an electric capacitor, and producing the flow of electric charge towards the grounding element, preventing the discharge from spreading to structures or people around.

### TECHNICAL FIELD

The present disclosure relates to electrical protection devices, particularly, it relates to devices for preventing atmospheric discharges.

### DESCRIPTION OF THE PRIOR ART

There are severe weather factors and conditions in nature, such as thunderstorms or electrical discharges, the latter also known as lightning, which are very common, dangerous and unpredictable.

When lightning strikes, it generates a current pulse that can reach tens of thousands of amperes, which in turn causes a transient surge in electrical systems. This can cause irreparable damage to equipment and appliances that are connected to the power grid, and even to people located around the lightning strike zone.

Although surges caused by atmospheric discharges have existed since the creation of electrical systems, the need to protect people and equipment, however, is nowadays much greater, due to the evolution of technology towards smaller components that are more sensitive to electromagnetic disturbances.

Identified in the prior art are disclosures such as U.S. Pat. No. 7,902,455B2, JP2016009534A, and JP2010205687A, which relate to electric shock protection devices.

Document U.S. Pat. No. 7,902,455B2 discloses a lightning arrester device for preventing damage to a structure from lightning during the approach of a storm cloud. The lightning arrester device includes a fixture piece that is installed at an upper end of a building and grounded, a rod attached at one end to the fixture piece to be electrically charged with a ground charge, a rod cap coupled with the other end of the rod to induce a lightning strike In addition, the lightning arrester device includes a discharge plate mounted on the rod below the rod cap, a charging tube having a cylindrical shape, formed by an insulating body to be insulated from the rod and electrically charged with charges having a polarity opposite to the ground charge, a charging plate coupled with the charging tube to be electrically charged with charges having a polarity opposite to the ground charge, and a plurality of pin charges arranged in the charging tube so that space charges in the air are charged on the pins by means of a storm cloud.

Also, it discloses that the discharge plate and the loading plate are shaped like an inverted parabola, which are arranged in a vertical direction and spaced apart from each other and each of the plates has circular holes for coupling with the rod. The discharge plate is approximately twice the diameter of the loading plate. Moreover, U.S. Pat. No. 7,902,455B2 discloses that one end of the loading tube is coupled with the insulating body, and the other end of the loading tube is coupled with a loading cap, thereby attaching the loading tube to the rod. Additionally, the paper discloses that when the ground charges are gradually charged on the discharge plate and the rod electrically connected to each other, the amount of charge is incremented to increase the charging voltage between the charging tube, the charging plate, the charging pins, between the discharge plate and the rod, thereby electrically discharging them.

In turn, document JP2016009534A discloses a lightning suppression device including a lightning protection pole element installed at the top, a connection element connected below the lightning protection pole element, a support element vertically connected to support the lightning pole element, and a mounting plate connected at the bottom of the support element. Also, the lightning protection post element includes an upper electrode body, a lower electrode body and an insulator located between the upper electrode body and the lower electrode body, and together have a spherical shape.

Moreover, this document discloses that the upper electrode body and the lower electrode body have a slightly flat hemispherical shape, with the sphere divided into upper and lower halves. Additionally, the document discloses that the device includes an insulator including a cylindrical insulator disposed between the upper electrode body and the lower electrode body, and a cover element arranged around the cylindrical insulator. Furthermore, the document discloses that the lower electrode body is electrically grounded through the support element, the mounting plate, and a grounding conductor.

Finally, document JP2010205687A, discloses a lightning arrester comprising a lightning post element, wherein the lightning post element includes an upper electrode body, a lower electrode body, a cylindrical insulator, and an insulation support. Also, the upper electrode body bas a hemispherical shape having a cylindrical upper concave portion, and a thick circumferential portion formed in the center of the upper electrode body. Also, the lower electrode body has a hemispherical shape having a cylindrical lower concave portion, and a thick circumferential portion formed in the center of the lower electrode body includes the thick circumferential portion.

Additionally, in the lightning arrester disclosed herein, the upper end portion of the cylindrical insulator is configured to be installed in an annular groove formed in the upper electrode body, and the lower end portion of the cylindrical insulator is connected to the lower electrode body and is configured to be installed in an annular groove. Also, the insulating support includes an inner cylindrical body and an outer cylindrical body disposed outside the inner cylindrical body. The inner cylindrical body and the outer cylindrical body are upper portions of the inner cylindrical body. The upper end of the outer cylindrical body is connected by an annular connecting flange (5c). Further, document JP2010205687A discloses that the cylindrical insulator is installed on the inner cylindrical body of the insulating support and that the lightning arrestor includes a conductive connecting screw rod. A portion of the upper end of the conductive connecting screw rod is configured to be able to screw into a mounting screw hole formed in the lower electrode body. In addition, the conductive connecting screw rod serves to conductively connect the lightning post element to ground through a portion of the lower electrode and functions as a connecting element connected to a building or similar structure.

However, the prior art does not disclose devices for decreasing or suppressing the corona effect that is caused by atmospheric discharges provoked by a thunderstorm cloud. In other words, none of the devices in the prior art provide any effective protection; on the contrary. they increase the possibility that the element or structure where they are installed will be struck by lightning, and that such impact will cause damage to the structure or people around.

### BRIEF DESCRIPTION OF THE INVENTION

The present disclosure relates to devices for preventing atmospheric discharges. Particularly. it relates to a shielding device against atmospheric discharges.

In one embodiment of the disclosure, the lightning shielding device comprises a first conductive element with a through-hole that extends along the length of the first conductive. Moreover, the device includes a second conductive element with a through-hole that extends along the length of the second conductive element and said second conductive element passes through the through-hole of the first conductive element. Additionally, the device includes a first insulating body that connects the first conductive element to the second conductive element. The device further includes a second insulating body that connects the first conductive element to the second conductive element.

In addition, the device includes a third conductive element passing through the first conductive element and the second conductive element, which is configured to connect to a grounding element. Also, the device includes a fourth conductive element connected to a first end of the second conductive element and to the third conductive element.

In this embodiment of the device, and embodiments including at least the aforementioned elements, the first insulating body and the second insulating body are configured to keep the first conductive element and the second conductive element separated, thereby electrically insulating them. When an electric charge is induced in the second, third and fourth conductive elements, an electric potential difference is generated between the first conductive element and the second conductive element. The electric potential difference between the first conductive element and the second conductive element generates an electric field that causes an electrostatic discharge and initiates the flow of electric charge through the third conductive element towards a ground element.

### BRIEF DESCRIPTION OF THE FIGURES

FIG. 1 shows a front view of a first embodiment of a shielding device against atmospheric discharges.

FIG. 2 shows an isometric and exploded view of the embodiment illustrated in FIG. 1.

FIG. 3 shows a structure in which an embodiment of the electrical charge shielding device is connected at its highest point.

FIG. 4 shows a structure in which an embodiment of the electrical charge shielding device is connected at its highest point.

FIG. 5 shows an embodiment of the lightning shielding device in which the first conductive element, the second conductive element and the third conductive element are separated and electrically insulated.

### DETAILED DESCRIPTION OF THE INVENTION

The present disclosure relates to devices for preventing atmospheric electric discharges. In particular, it relates to a shielding device against atmospheric discharges (20), hereinafter referred to as device (20).

To understand the operation of the device (20) it is worth mentioning that atmospheric discharges or lightning originate from clouds called Cumulonimbus or Storm Clouds, during the process of formation of these clouds, and until their maturity, they alter the natural electric field of the earth, and any element on the ground or terrain that is under their electric shadow acquires positive electric charges by induction; this is an inevitable natural phenomenon. The highest concentration of these positive electric charges occurs in the upper part of buildings and in tall elements and/or structures, and it is further accentuated if metallic elements with pointed ends are installed on these buildings, elements, or structures.

Therefore, under normal atmospheric conditions the charge polarity of the ground or terrain is negative, while in the presence of storm clouds the polarity of the ground changes. As negative charges originate in the storm cloud, its electrostatic field induces charges to the ground, and all elements under the electric shadow of the cloud. The induced charge will have the same electric potential, but with the opposite sign.

In the case of electrical towers, communication towers, and similar structures, they become polarized with an excess of positive charges, and their geometric shape facilitates a higher concentration of these charges in their upper part. The negative charge in the lower part of the cloud and the positive charge induced to the ground and its elements create an electric field in the space between them, and this electric field can vary considerably from 100 V/m to 10,000 V/m.

According to the above, two polarities are established: a negative one at the base of the cloud and a positive one at the top of the tower or structure. The intensity of the electric potential induced in the tower is equal to the intensity of the electric potential of the charge at the base of the cloud. Therefore, there are two charges of equal potential but of opposite polarity, and these charges interact and will always tend towards a gradual equilibrium. This tendency to gradual equilibrium is disrupted when a descending negative leader is born from the cloud, and as this leader approaches the ground, the electric field at the top of the tower increases even more.

This increase in the electric field ionizes the air around it, generating an avalanche of positive charges, forming ascending connection leaders that propagate through the air to intercept the descending leader and complete the connection process, which is known as atmospheric discharge or lightning. The encounter of the ascending leader with the descending leader produces a violent equalization of charges in the electric field created between the cloud and the tower.

In the case of electrical towers, communication towers, and similar structures, many lightning discharges are of the upward induced discharge type. Atmospheric discharges on these structures cause damage to equipment and loss of service continuity.

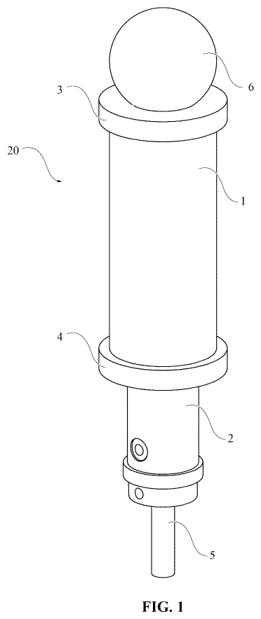

Referring to FIG. 1, in a first embodiment of the disclosure, the device (20) comprises:
a first conductive element (1) with a through-hole that extends along the length of the first conductive element (1);
a second conductive element (2) with a through-hole that extends along the length of the second conductive element (2), the second conductive element (2) passes through the through-hole of the first conductive element (1):
a first insulating body (3) that connects the first conductive element (1) to the second conductive element (2);
a second insulating body (4) that connects the first conductive element (1) to the second conductive element (2);
a third conductive element (5) that passes through the first conductive element (1) and the second conductive element (2) and is configured to connect to a grounding element (10); and
a fourth conductive element (6) connected to a first end (2A) of the second conductive element (2) and to the third conductive element (5).

Moreover, referring to FIG. 1, in a preferred embodiment, the device (20) comprises the first conductive element (1). The first conductive element (1) may also have a polyhedron shape and not limited to, e.g., a triangular, rectangular or hexagonal prism shape. Additionally, the first conductive element (1) may have a non-polyhedral shape and not limited to, e.g., a cylindrical, conical, spherical and/or any other similar shape known to a person of ordinary skill in the art.

Also, referring to FIG. 1, the device (20) comprises a second conductive element (2) with a through-hole that extends along the length of the second conductive element (2), and said second conductive element (2) passes through the through-hole of the first conductive element (1). In addition, the second conductive element (2) may have the same shape as the first conductive element (1).

Furthermore, in a preferred embodiment of the present disclosure, the first conductive element (1) and the second conductive element (2) have a cylindrical shape.

Additionally, the first conductive element (1) and the second conductive element (2) may have a large void space relative to their volume, in other words, both the first conductive element (1) and the second conductive element (2) may have a hollow shape.

Preferably, the first conductive element (1) and the second conductive element (2) are concentrically aligned.

One of the advantages of the concentric alignment of the first conductive element (1) and the second conductive element (2), and that both the first conductive element (1) and the second conductive element (2) have a cylindrical in shape, is that it allows the device (20) to increase the contact area with the atmosphere of the first conductive element (1) that is electrically charged, thereby reducing the likelihood that a structure (11) will become electrically charged and generate an ascending leader.

Specifically, the diameter of the first conductive element (1) ranges from 2 cm to 10 cm and the diameter of the second conductive element (2) ranges from 1 cm to 9.5 cm.

Additionally, the first conductive element (1) and the second conductive element (2) can be made of a material selected from stainless ferrous conductive materials, non-ferrous conductive materials, and/or combinations thereof. For example, the first conductive element (1) and the second conductive element (2) can be made of a conductive material selected from aluminum, copper, and alloys thereof.

In the present disclosure, “conductive element”, “conductive material” or “electrically conductive element” refer to a material that has electrical conductivity allowing the flow of electric current. Examples of conductive materials are those with resistivity lower than 0.001Ω/m. Other examples of conductive materials referred to in the present disclosure are materials with resistivity lower than 1×10⁵Ω/m. Further, examples of conductive materials include metals, such as metals selected from, aluminum, copper, and alloys thereof, carbon steel, cast iron, galvanized iron, chromium steels, chromium-nickel steels, chromium-nickel-titanium steels, nickel-chromium-molybdenum-tungsten alloy, chromium-molybdenum ferrous alloys, stainless steel 301, stainless steel 302, stainless steel 304, stainless steel 316, stainless steel 405, stainless steel 410, stainless steel 430, stainless steel 442, manganese-alloyed steel and/or combinations thereof.

Also, the device (20) comprises a first insulating body (3) that connects the first conductive element (1) to the second conductive element (2). Additionally, the first insulating body (3) is connected to a first end (1A) of the first conductive element and to a first end (2A) of the second conductive element (2).

Moreover, the device (20) comprises a second insulating body (4) connecting the first conductive element (1) to the second conductive element (2). The second insulating body (4) is further connected to a first end (1B) of the first conductive element and to a first end (28) of the second conductive element (2).

Advantageously, the first insulating body (3) and the second insulating body (4) help keep the first conductive element (1) separated from the second conductive element (2), thereby achieving electrical insulation between the first conductive element (1) and the second conductive element (2).

Moreover, in the present disclosure, “insulating body”, “insulating material”, or “dielectric material” refer to a material that has electrical conductivity restricting the flow of electric current. Examples of insulating materials are materials with resistivity greater than 100Ω/m. Other examples of insulating materials referred to in the present disclosure are materials with resistivity greater than 1000Ω/m. Also, other examples of insulating materials are polymeric materials, such as polymeric materials selected from polymethylmethacrylate (PMMA), polyvinyl chloride (PVC); chlorinated polyvinyl chloride (CPVC); polyethylene terephthalate (PET), polyamides (PA) (e.g. PA12, PA6, PA66); polychlorotrifluoroethylene (PCTFE); polyvinylidene fluoride (PVDF); polytetrafluoroethylene (PTFE); ethylene-chlorotrifluoroethylene (ECTFE); plastics (polyester, vinylester, epoxy, vinylic resins) reinforced with fibers (e.g. glass, aramid, polyester), cross-linked polyethylene (PEX)).

In a preferred embodiment, the first insulating body (3) and the second insulating body (4) have a ring shape, with the ring comprising a first ring with an outer diameter, and a second ring connected and concentric with the first ring, wherein said second ring has a smaller outer diameter than the first ring.

Also, the first ring with an outer diameter of the first insulating body (3) and the first ring with an outer diameter of the second insulating body (4) can be coupled to the first conductive element (1), so that the first ring with an outer diameter of the first insulating body (3) is connected to a first end (1A) of the first conductive element (1) and the first ring with an outer diameter of the second insulating body (4) is connected to a second end (1B) of the first conductive element (1).

Further, the second ring of the first insulating body (3) and the second ring of the second insulating body (4) can be coupled to the second conductive element (2), so that the second ring of the first insulating body (3) is connected to a first end (2A) of the second conductive element (2) and the second ring of the second insulating body (4) is connected to a second end (2B) of the second conductive element (2).

In one embodiment of the present disclosure, the diameter of the first insulating body (3) and the diameter of the second insulating body (4) range between 1 cm and 11 cm.

Preferably, the first insulating body (3) and the second insulating body (4) can be made of a material selected from elastic polymers, thermoplastic polymers, thermosetting polymers and/or combinations thereof

In one embodiment of the device (20), the length of the first conductive element (1) and the second conductive element (2) can range between 30 cm and 300 cm.

Also, the device (20) comprises a third conductive element (5) that passes through the first conductive element (1) and the second conductive element (2), and the third conductive element (5) is configured to connect to a grounding element (10).

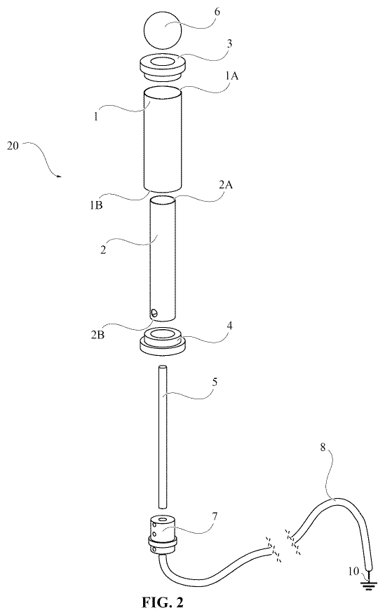

Additionally, the third conductive element (5) can be made of a material selected from stainless ferrous conductive materials, non-ferrous conductive materials, and/or combinations thereof. For example, the third conductive element (5) can be made of a conductive material selected from aluminum, copper, and/or alloys thereof. Furthermore, in one embodiment of the present disclosure and referring to FIG. 2, the third conductive element (5) may have a shape similar to the first conductive element (1) and/or the second conductive element (2). The third conductive element (5) may, e.g., have a cylindrical shaped, flat shape, and/or not be limited to a prism shaped in any of its variations.

In one embodiment of the device (20), the length of the third conductive element (5) ranges between 40 cm and 300 cm.

Also, referring to FIG. 2, the third conductive element (5) may comprise a male threaded joint at one of its ends. The third conductive element (5) further comprises a connection port (7) that is longitudinally opposite to the male threaded joint of the third conductive element (5), and the connection port (7) may be configured to couple to the third conductive element (5).

Moreover, the connection port (7) may be a non-removable or removable and/or replaceable connecting element.

It will be understood in the present disclosure that the connection port (7) may be an electrical device or terminal that allows the third conductive element (5) to be joined to another conductive element, either temporarily or permanently. The connection port (7) may also be selected from, and not limited to, bimetallic compression terminals, joining screws, bimetallic slot connectors, square sleeves, T-sleeves, linear sleeves, parallel sleeves, split bolt H-type sleeves, and/or universal sleeves.

Furthermore, the connection port (7) can be made of a material selected from brass, nickel-plated brass, aluminum, aluminum alloy, copper, electrolytic copper, stainless steel, galvanized steel, bronze and/or combinations thereof.

Also, it will be understood in the present disclosure that the grounding element (10) may be a non-energized point, e.g., it may be the ground or terrain on which a building or structure (11) rests. Additionally, the grounding element (10) ensures that there are no dangerous potential differences, and it allows atmospheric discharge or fault currents to flow thereto.

Referring to FIG. 2, the third conductive element (5) may also comprise a fifth conductive element (8) configured to couple to the connection port (7) and connect to the grounding element (10).

Preferably, the fifth conductive element (8) can be made of a material selected from galvanized steel, copper-plated steel and/or copper.

Additionally, the fifth conductive element (8) may be selected from, but not limited to, stranded cables, solid round cables, PVC-coated stranded cables, PVC-coated solid round cables, rigid bars and/or any other grounding element known to a person of ordinary skill in the art.

Moreover, the device (20) comprises a fourth conductive element (6) connected to a first end (2A) of the second conductive element (2) and to the third conductive element (5).

In a preferred embodiment of the present disclosure, the fourth conductive element (6) has a spherical shape. Additionally, the fourth conductive element (6) may have a female threaded joint that allows the fourth conductive element (6) to connect to the male threaded joint of the third conductive element (5), thus enabling electrical communication between the fourth conductive element (6) and the third conductive element (5).

In another embodiment of the device (20), the fourth conductive element (6) may also be a solid sphere, or it may be a monolithic spherical shell (e.g., made of a single piece). For example, the monolithic spherical shell may comprise two or more parts connected to each other by a non-removable joining element. Preferably, the non-removable joining means ensure that all parts of the monolithic spherical shell are electrically connected.

Additionally, the fourth conductive element (6) can be made of a material selected from stainless ferrous conductive materials, non-ferrous conductive materials, and/or combinations thereof For example, the fourth conductive element (6) can be of a conductive material equal to the material of the first conductive element (1) and the second conductive element (2).

Also, in one embodiment of the device (20), the diameter of the fourth conductive element (6) ranges between 6 cm and 12 cm.

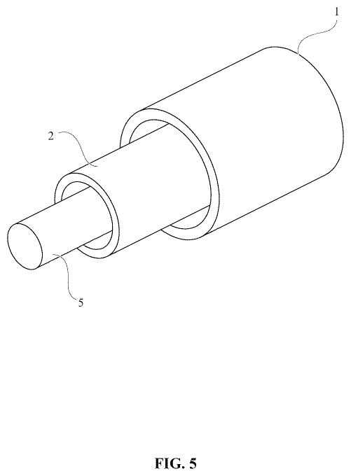

Referring to FIG. 5, the first conductive element (1) and the second conductive element (2) are arranged to leave a space between them, so that when the first conductive element (1) and the second conductive element (2) are electrically charged with opposite charges, and have a dielectric body or insulating body (e.g., air) in between, the device (20) is configured as a type of cylindrical capacitor in which an electrostatic discharge generates a flow of electric charge that travels through the third conductive element (5) towards the grounding element (10).

Also, when an electric charge is induced on the conductive elements (2, 5, 6), an electric potential difference is generated between the first conductive element (1) and the second conductive element (2).

In the embodiments of the device (20) where the fourth conductive element (6) has a spherical shape, this shape allows the positive charges induced by a storm cloud to be uniformly distributed across the entire surface of the device (20). The induced charge potential in the device (20), including the second conductive element (2), will be proportional to the charge of the cloud but with opposite sign. The third conductive element (5) is connected to the fourth conductive element (6), wherein the third conductive element (5) may be connected to the grounding element (10) or any type of grounding system by means of a down conductor.

During a thunderstorm, the charges in the first conducting element (1) and the second conducting element (2) seek an electrical equilibrium state, distributing the electrical charge between the first conducting element (1) and the second conducting element (2). When a very intense electric field is established between two points of a dielectric or in the air, it can ionize the medium and cause a spark to jump. Therefore, the charges acquired by the first conductive element (1) and the second conductive element (2) establish an electric potential difference, and this potential difference creates an electric field that acts in the air that separates the first conductive element (1) and the second conductive element (2).

The positive electrical charges separated by air are concentrated on the outer surface of the second conductive element (2) and the negative electric charges separated by air concentrate on the inner wall of the first conductive element (1). The attraction between the positive and negative charges in the first conductive element (1) and the second conductive element (2) will become large enough to cause electrons to jump the dielectric or air gap separating the first conductive element (1) and the second conductive element (2)

On the other hand, the electric potential difference between the first conductive element (1) and the second conductive element (2) generates an electric field that causes an electrostatic discharge and initiates the flow of electric charge through the third conductive element (5) towards the grounding element (10).

It is considered that the electric field between the storm cloud and the exposed elements comprising the device (20) may vary between 10 kV/m and 30 kV/m. Advantageously, the greater the electric field, the greater the number of electrostatic discharges inside the device (20), allowing the device (20) to maintain a low concentration of static electric charges on all conductive elements exposed to the atmosphere, referenced to the grounding element (10) and equipotentialized with the device (20).

Also, advantageously, the control exerted by the device (20) over the induced charges does not allow the accumulation of such charges, thus preventing point discharge or corona effect.

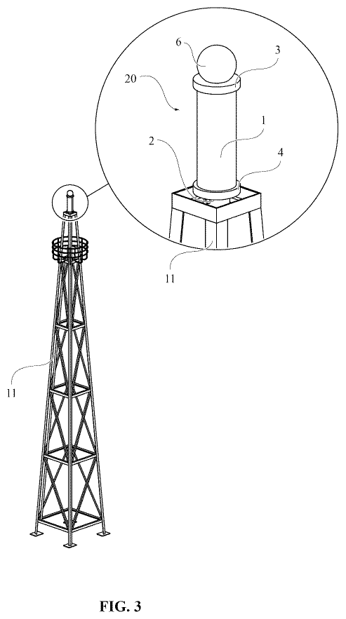

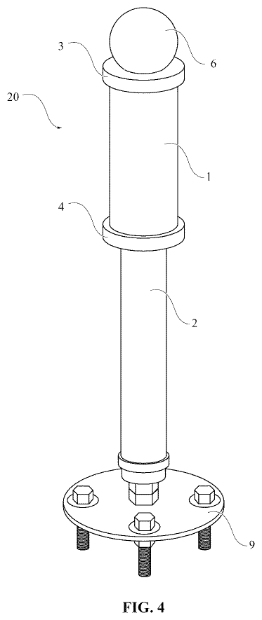

Referring to FIG. 3 and FIG. 4, an embodiment of the device (20) is shown, which is coupled to a structure (11). Examples of structure (11) may be telecommunications towers, including, but are not limited to, self-supporting triangular towers, guyed towers, monopole towers, fast site towers, guyed masts, mobile towers, camouflaged towers. Additionally, examples of structure (11) may include, but not be limited to, electrical towers, suspension towers, stay towers, anchor towers, angle towers, end-line towers, and special towers. Other examples of structure (11) may include house roofs, building decks, tanks, flagpoles, ship masts, supporting steel structures, reinforced concrete supporting structures, and/or similar structures known to a person of ordinary skill in the art.

Referring to FIG. 4, an embodiment of the device (20) is shown, which also includes a support element (9) coupled to the second conductive element (2) and configured to connect to a structure (11). In this embodiment, the support element (9) can be coupled to a flat surface of a structure (11), e.g., the rooftop of a residential complex or a corporate building.

One of the advantages of the support element (9) is to keep the second conductive element (2) stable with respect to the first conductive element (1). The support element (9) can be a base, a hardware system, a vertical support, a horizontal support, an anchoring system, a mast, combinations of the above and/or any other equivalent support element known to a person of ordinary skill in the art. Preferably, the support element (9) is made of a conductive material or electrically conductive material.

Another technical effect of the support element (9) is to position the device (20) at a height. greater than the maximum height of the structure (11) to reduce the point effect of the device (20).

In addition, the support element (9) can be made of a material selected from galvanized steel, stainless steel and/or combinations of the above.

### Example 1

The first example of the device (20) bas a first conductive element (1) that is a hollow cylinder with a diameter of 2.5 cm and a length of 200 cm. On the other hand, the device (20) also has second conductive element (2), which like the first conductive element (1) is a hollow cylinder, but with a diameter of 1.9 cm and a length of 300 cm. The hollow cylinder with a diameter of 1.9 cm is arranged inside the cylinder with a diameter of 2.5 cm, so that the second conductive element (2) passes through the first conductive element (1). One end of the cylinder with a diameter of 2.5 cm corresponds to a first end (1A) and the other end of said cylinder corresponds to a second end (1B). Similarly, one end of the cylinder with a diameter of 1.9 cm corresponds to a first end (2A), and the other end of said cylinder corresponds to a second end (2B).

Also, the device (20) has two ring-shaped insulating elements or elastomers, corresponding to a first insulating body (3) and a second insulating body (4) Both elements are connected to the ends of the first conductive element (1) and the second conductive element (2), i.e., the ends (1A, 1B, 2A, 2B), allowing the first conductive element (1) and the second conductive element (2) to be separated and electrically be insulated from each other.

A solid aluminum sphere is connected to a section of the first insulating body (3) that connects to the first end (IA) of the first conductive element (1) and to the first end (2A) of the second conductive element (2). The solid sphere corresponds to a fourth conductive element (6) and said sphere has a diameter of 7 cm. Additionally, a section of the solid sphere that connects to the first insulating body (3) has a female threaded joint M22x2x10 that receives a male threaded portion M20x2x18 of one end of a galvanized steel rod in the shape of a tube, and said rod corresponds to a third conductive element (5).

The galvanized steel rod has a length of 300 cm, and at the other end, it is coupled to a bimetallic slot connector, which corresponds to a connection port (7). In addition, the bimetallic slot connector is connected to a stranded galvanized steel cable with a length of m, which corresponds to a fifth conductive element (8). This cable runs through a building with a height of 25 m. The building corresponds to a structure (11) and, on its rooftop, communication and electrical equipment are installed. Additionally, the stranded galvanized steel cable connects the galvanized steel rod to the ground or terrain, which corresponds to a grounding element (10).

The device (20) may be located at the highest part of the building, e.g., in a corner of the rooftop, and the device (20) is attached to a base fixed to the rooftop by means of an anchoring mechanism.

With this configuration the attraction between the positive and negative charges present in the first conductive element (1) and the second conductive element (2) will become large enough to cause electrons to jump the dielectric or air gap separating the first conductive element (1) and the second conductive element (2). This continuous action within the device (20) prevents the concentration of excess positive charges, thus avoiding the emission of ascending leaders from the protected structure (11), so that if there is no emission of ascending leaders the chances of direct lightning strikes on the protected structure are minimized.

### Example 2

The device (20) of Example 1 was modified, wherein the length of the first conductive element (1), i.e., the first hollow cylinder has a length of 100 cm, and the second conductive element (2), which corresponds to the second hollow cylinder, bas a length of 200 cm. On the other hand, the device (20) is located on the highest part of a communications tower, which corresponds to a structure (11), and the device (20) is attached to said structure by means of a hardware arranged between the second hollow cylinder and the communications tower. The dimensions of the device (20) facilitated the placement of the device (20) at the highest section of the tower, allowing the device (20) to protrude above the normal height of the tower.

With this configuration and under the influence of a storm cloud, the device (20), similar to Example 1, does not allow the concentration of excess positive charges, thus preventing the emission of ascending leaders from the telecommunications tower. By preventing the emission of ascending leaders from said structure, it minimizes the chances of direct lightning strikes on the protected telecommunications tower. In this way, it was possible to protect the antennas and cellular communication radios installed at the top of the tower from an electric discharge, as well as to protect the communications equipment installed at the base of the tower by preventing the point effect.

### Example 3

The device (20) of Example 2 was modified by increasing the length of the stranded galvanized steel cable, i.e., the fifth conductive element (8), which now has a length of 65 m.

With this configuration it was possible to place the device (20) on the mast of a taller communications tower, and although the device (20) protrudes above the height of the tower, the configuration also prevents the emission of ascending leaders, prevents the corona effect, and prevents damage to the communications equipment installed on the tower, and prevents the discharge from spreading to nearby homes or other buildings.

It is to be understood that the present invention is not limited to the described and illustrated embodiment, as it will be evident to a person of ordinary skill in the art that there are possible variations and modifications that do not depart from the spirit of the invention, which is only defined by the following claims.

1. An atmospheric discharge shielding device (20), comprising:
a first conductive element (1) with a through-hole that extends along the length of the first conductive element (1);
a second conductive element (2) with a through-hole that extends along the length of the second conductive element (2); the second conductive element (2) passes through the through-hole of the first conductive element (1);
a first insulating body (3) that connects the first conductive element (1) to the second conductive element (2);
a second insulating body (4) that connects the first conductive element (1) to the second conductive element (2),
a third conductive element (5) that passes through the first conductive element (1) and the second conductive element (2), and is configured to connect to a grounding element (10); and
a fourth conductive element (6) connected to a first end (2A) of the second conductive element (2) and to the third conductive element (5),
wherein the first insulating body (3) and the second insulating body (4) are configured to keep the first conductive element (1) separated from the second conductive element (2) and thus electrically insulate them;
wherein, when an electric charge is induced in the conductive elements (2, 5, 6), an electric potential difference is generated between the first conductive element (1) and the second conductive element (2); and
wherein the electric potential difference between the first conductive element (1) and the second conductive element (2) generates an electric field that causes an electrostatic discharge and initiates the flow of electric charge through the third conductive element (5) towards a grounding element (10).

2. The device of claim 1, wherein the first conductive element (1) and the second conductive element (2) are cylindrical in shape.

3. The device of claim 1, wherein the length of the first conductive element (1), the second conductive element (2) and the third conductive element (5) ranges between 40 cm and 300 cm.

4. The device of claim 1, wherein the first conductive element (1), the second conductive element (2), the third conductive element (5), and the fourth conductive element (6) are made of a material selected from stainless ferrous conductive materials, non-ferrous conductive materials and/or combinations thereof.

5. The device of claim 1, wherein the fourth conductive element (6) has a spherical shape.

6. The device of claim 1, wherein the third conductive element (5) comprises:
a connection port (7) configured to couple to the third conductive element (5); and
a fifth conductive element (8) configured to couple to the connection port (7) and connect to the grounding element (10).

7. The device of claim 1, wherein the fifth conductive element (8) is made of a material selected from galvanized steel, copper-plated steel, and/or copper.

8. The device of claim 1, wherein the first insulating body (3) and the second insulating body (4) are made of a material selected from elastic polymers, thermoplastic polymers, thermosetting polymers and/or combinations thereof.

9. The device of claim 1, further comprising a support element (9) coupled to the second conductive element (2) and configured to connect to a structure (11).

10. The device of claim 1, wherein the support element (9) is made of a material selected from galvanized steel, stainless steel, and/or combinations thereof.
